(19) United States
(12) Patent Application Publication
(10) Pub. No.: US 2012/0190397 A1
(43) Pub. Date: Jul. 26, 2012

(54) METHOD FOR TRANSMITTING SIGNAL IN MACHINE TO MACHINE COMMUNICATION

(75) Inventors: Soojung JUNG, Daejeon (KR); Jae Sun Cha, Daejeon (KR); Chul Sik Yoon, Seoul (KR); Namgi Kim, Suwon-si (KR)

(73) Assignees: Kyonggi University Industry and Academia Cooperation Foundation, Suwon-si (KR); Electronics and Telecommunications Research Institute, Daejeon (KR)

(21) Appl. No.: 13/345,094

(22) Filed: Jan. 6, 2012

(30) Foreign Application Priority Data
Jan. 7, 2011 (KR) 10-2011-0001740
Jan. 5, 2012 (KR) 10-2012-0001625

(51) Int. Cl. H04W 4/08

(52) U.S. Cl. 455/519

(57) ABSTRACT

A method of relaying a base station that operates as a relay link in order for a first base station to communicate with a second base station that is connected to backhaul includes: forming, by the first base station, a relay station with the second base station; and starting, by the first base station, a relay mode.

### CROSS-REFERENCE TO RELATED APPLICATION

This application claims priority to and the benefit of Korean Patent Application No. 10-2011-0001740 and No. 10-2012-0001625 filed in the Korean Intellectual Property Office on Jan. 7, 2011 and Jan. 5, 2012, respectively, the entire contents of which are incorporated herein by reference.

### BACKGROUND OF THE INVENTION

(a) Field of the Invention

The present invention relates to a method of transmitting a signal in machine to machine (M2M) communication.

(b) Description of the Related Art

In an M2M communication system, M2M communication is communication that performs an information exchange between a terminal and a base station as a system that embodies the Internet of Things concept, or an information exchange between terminals with only machines without human interaction. Services that can be embodied using M2M communication may include security access, a surveillance service, tracking, tracing, a recovery service, a public safety service, an automatic payment service, a healthcare service, a remote maintenance and control service, and a smart metering service.

An application program that is provided by a specific subscriber in such an M2M communication system requests to efficiently transmit common data to a plurality of terminals. For example, in a plurality of terminal apparatuses, data traffic of the same contents when transmitting command data “report a present state” is simultaneously transmitted to a plurality of other terminals, and in an existing communication standard, because a method that can effectively simultaneously transmit the same data to a plurality of terminals does not exist, the same data should be individually transmitted to each terminal and thus a radio resource is wasted.

Further, in an M2M communication system having characteristics in which a plurality of terminals coexist, a plurality of terminals should be efficiently managed and controlled. However, because a present communication system cannot support such a control method, by transmitting an individual control signal to a plurality of terminals, a radio resource is wasted.

### SUMMARY OF THE INVENTION

The present invention has been made in an effort to provide an efficient method of simultaneously controlling a plurality of terminals and a method of efficiency transmitting common data to terminals.

An exemplary embodiment of the present invention provides a method in which a base station transmits a signal to a plurality of terminals in an M2M communication system, the method including: grouping at least one of the plurality of terminals into a group terminal belonging to one group; and allocating an M2M device group ID (MGID) that identifies the group terminal.

The method may further include transmitting common data at one time to the group terminal.

The transmitting of common data at one time to the group terminal may include transmitting, when the group terminal is in an idle state, a paging broadcasting message to the group terminal.

The paging broadcasting message may be transmitted with a multicast method.

The paging broadcasting message may include information representing a transmission time point of a burst in which the common data are included.

The paging broadcasting message may be transmitted through a broadcast map information element (MAP IE).

A code for multicast assignment information may be used as a code for cyclic redundancy check masking in the broadcast MAP IE.

The paging broadcasting message may be transmitted through a multicast MAP IE.

After the group terminal receives the common data, a state of the group terminal may be converted to a connection state.

Another embodiment of the present invention provides method in which a base station transmits a signal to a plurality of terminals in an M2M communication system, the method including: grouping at least one of a plurality of terminals into a group terminal belonging to one group; and transmitting common data at one time to the group terminal.

The transmitting of common data at one time to the group terminal may include transmitting, when the group terminal is in an idle state, a paging broadcasting message to the group terminal.

The paging broadcasting message may be transmitted with a multicast method.

The paging broadcasting message may include information representing a transmission time point of a burst in which the common data are included.

The paging broadcasting message may be transmitted through a broadcast MAP IE.

A code for multicast assignment information may be used as a code for cyclic redundancy check masking in the broadcast MAP IE.

The paging broadcasting message may be transmitted through a multicast MAP IE.

After the group terminal receives the common data, a state of the group terminal may be converted to a connection state.

### BRIEF DESCRIPTION OF THE DRAWINGS

FIG. 1 is a diagram illustrating an M2M communication system according to an exemplary embodiment of the present invention.

FIG. 2 is a flowchart illustrating a method of allocating an identifier of a terminal in an M2M communication system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may indicate a terminal, a mobile terminal (MT), a subscriber station (SS), a portable subscriber station (PSS), an access terminal (AT), and user equipment (UE), and may include an entire function or a partial function of the terminal, the MT, the SS, the PSS, the AT, and the UE.

Further, a base station (BS) may indicate a node B, an evolved node B (eNode B), an access point (AP), a radio access station (RAS), a base transceiver station (BTS), and a mobile multihop relay (MMR)-BS, and may include an entire function or a partial function of the node B, the eNode B, the AP, the RAS, the BTS, and the MMR-BS.

Hereinafter, an M2M communication system according to an exemplary embodiment of the present invention will be described in detail.

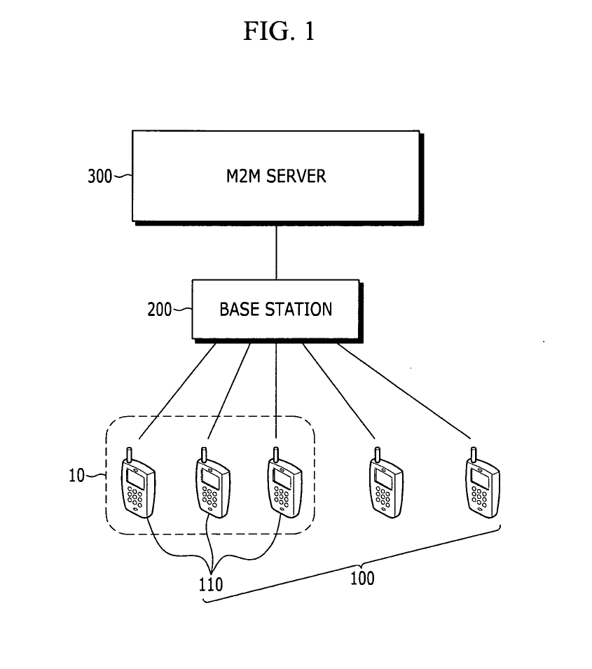

FIG. 1 is a diagram illustrating a basic M2M service system architecture according to an exemplary embodiment of the present invention.

Referring to FIG. 1, the basic M2M service system architecture includes a plurality of terminals 100, a BS 200, and an M2M server 300.

Characteristics and requirements that are distinguished from an existing standard of such a basic M2M service system architecture, for example, a communication system according to the Institute of Electrical and Electronic Engineers (IEEE) 802.16e and IEEE 802.16m, are as follows.

First, extremely low power consumption is requested. Equipment to be used for M2M communication should be able to operate in an extremely low power state for a long time period. Even in a situation in which it is difficult to directly supply power and in which a person's interaction does not operate for a long time period, and in which it is difficult to exchange a plurality of sensor devices, the basic M2M service system architecture should operate for a long time period with a battery and thus the equipment to be used for M2M communication is necessary.

Next, high reliability is requested. The equipment that is used for M2M communication is requested for a reliable connection and transmission between the terminal 100 and the server at any time and everywhere while performing M2M communication. That is, even when the terminal 100 moves or channel quality changes, the terminal 100 and the server should be able to connect while securing high reliability. The equipment may be requested by an application program that transmits emergency data or sensitive data while performing an M2M communication service, and such an application service program may include healthcare, security control, surveillance, public safety, payment, remote control, and control service.

Next, improved access priority is requested. The improved access priority is the right that can provide priority to the terminal 100 when the terminal 100 approaches a server through a network. A priority access may be used for terminals 100 requiring warning communication, emergency communication, or an immediate spotlight. This element may be also requested in healthcare, secured access, surveillance, public safety, remote control, and a control service.

Next, transmission to a plurality of terminals 100 is requested. Because the terminal 100 hardly requests human interaction, a plurality of terminals 100 may be simultaneously operated in a service. Therefore, a method of efficiently transmitting a signal to the plurality of terminals 100 is a core element in the basic M2M service system architecture. That is, the plurality of terminals 100 should be able to be simultaneously and smoothly connected to a network through a BS.

Next, an address system of the plurality of terminals 100 is requested. Because the plurality of terminals 100 should be able to be operated in the basic M2M service system architecture, a terminal address system appropriate for the plurality of terminals 100 is necessary.

Next, a group control is requested. For efficient control and operation of the plurality of terminals 100, in the basic M2M service system architecture, a method of combining the plurality of terminals 100 on a group basis, efficiently controlling this, and transmitting data is necessary.

Next, security is requested. That is, in basic M2M service system architecture, security for providing integrity and air-tightness is surely necessary. In a long distance network, a malicious security threat may be omnidirectionally represented without division of hardware, software, and firmware through a physical or remote attack. Therefore, in a long distance network, the basic M2M service system architecture should have an appropriate security system that can necessarily authenticate and recognize mechanical apparatuses for the terminal 100 and the network equipment.

Nest, transmission of a small size is requested. Transmission of data of a very small size may be a phenomenon that frequently appears by characteristics of an M2M system including a plurality of sensors. Therefore, the basic M2M service system architecture should be designed to transmit a very small amount of data with only a very small load.

Next, low mobility is requested. A partial service of an M2M communication service requests a very low power operation, and this has an influence on mobility of a mechanical apparatus. That is, in order to operate terminals 100 with very low power, it is necessary that the terminals 100 have no motion or that motion of the terminals 100 is limited to a predetermined distance. Therefore, the basic M2M service system architecture that provides such a service can minimize a system load by simplifying operations for motion of the terminal 100.

Next, a time change operation is requested. The basic M2M service system architecture can be embodied to increase efficiency of a system through a low access priority or slowed data transmission for a time change service.

Next, uni-direction data traffic transmission is requested. The basic M2M service system architecture may have characteristics that transmit data only to the terminal 100 according to a target service or data only to a server. In this case, control data can be transmitted bi-directionally.

Next, an extremely low delay time is requested. The basic M2M service system architecture may request to transmit desired data within an extremely low delay time according to a target service. In order to embody this, the basic M2M service system architecture requires greatly lowered network access delay and data transmission delay.

Next, an extremely long control range is requested. A specific M2M communication service needs to include a very wide area at one time. This element is not a requirement in which the basic M2M service system architecture should necessarily include, but when the M2M communication system includes this element, an economical effect can be maximized.

Next, rare traffic transmission is requested. A specific M2M communication service may request only irregular transmission of data traffic from the terminal 100 or to the terminal 100. Therefore, an efficient power strategy method appropriate thereto is necessary.

Hereinafter, in the basic M2M service system architecture, a method of grouping a plurality of terminals 100 according to a service and effectively transmitting common data and a control signal to the terminal 100 belonging to a corresponding group will be described in detail.

According to an exemplary embodiment of the present invention, at least one of a plurality of terminals 100 may be combined as one group 10 by a subscriber that provides a service to the terminal 100 within the basic M2M service system architecture, and an identifier thereof may be allocated to a corresponding group 10. Such an identifier is referred to as an M2M device group ID (MGID) within the basic M2M service system architecture, and when the terminal 100 is firstly registered at the communication system, the identifier is allocated together with an M2M device ID (MDID) of the terminal 100. The MDID of the terminal 100 within the basic M2M service system architecture is an identifier that uniquely distinguishes the terminal 100 of a connection state within a BS and is recovered to a BS when a state of the terminal 100 is changed to an idle state. In a process in which the terminal 100 performs a procedure that enters a communication system, until registration is complete, a temporary MDID may be used, and this uses a portion of an MDID area of the terminal 100. The MDID of the terminal 100 in the basic M2M service system architecture is used for connection to and release from a system of the terminal 100 by a BS and for a state control of the terminal 100 like a terminal identifier (STID) of a conventional communication system.

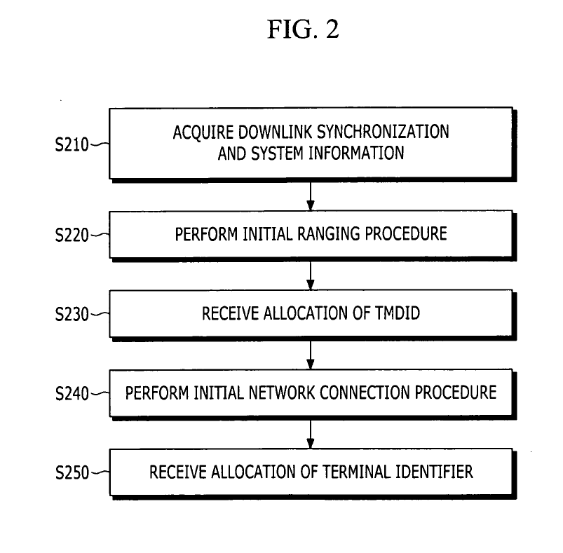

Hereinafter, a method of allocating an identifier of a terminal will be described in detail with reference to FIG. 2.

FIG. 2 is a flowchart illustrating a method of allocating an identifier of a terminal according to an exemplary embodiment of the present invention.

Referring to FIG. 2, the terminal 100 attempting to connect to a system acquires downlink synchronization and system information (S210). Thereafter, the terminal 100 performs an initial ranging procedure based on the acquired system information (S220).

After a ranging procedure is successfully performed, the terminal 100 receives allocation of a temporary terminal identifier (TMDID) from the BS 200 (S230). Thereafter, the terminal 100 performs an initial network connection procedure, for example, capacity negotiation, authentication, and key exchange, using the allocated TMDID (S240). When a registration to the network is complete, the terminal 100 receives allocation of a terminal identifier (MDID) from the BS 200 (S250). In this case, allocation of the TMDID is released.

The MDID of the terminal 100 may have the same length (12 bits) as that of an STID of a conventional communication system in consideration of backward compatibility. When entering an idle state with an MDID in an idle state in addition to an MDID in a connection state of the terminal 100, a deregistration ID (DID) of a conventional communication system, for example, IEEE 802.16m, may be additionally allocated.

In the basic M2M service system architecture, an MGID of the terminal 100 is sustained even in an idle state in which a connection of the terminal 100 is released from the system, and may be updated by the system or the BS 100. A length of the MGID of the terminal 100 within the basic M2M service system architecture can be determined according to a method of using the MGID. When using for only a group of terminals in an idle state, the length of the MGID may be 24 bits, which is the same length as that of a DID in an idle state of a conventional communication system, for example, IEEE 802.16m, or a length of media access control (MAC) address hash of another conventional communication system, for example, IEEE 802.16e. When the MGID is used for control and data transmission of terminals of a connection state as well as an idle state, in consideration of backward compatibility, the length of the MGID may be the same length of 12 bits as that of an STID in a connection state of a conventional communication system, for example, IEEE 802.16m. Even when allocated equally to the STID of the conventional communication system, the MDID uses another identifier allocation area. The terminal group 10 that is distinguished by the MGID may be generated by a terminal kind, a user, and an application program in addition to a terminal subscriber. Further, according to a unique range of the MGID, the BS 200 and a control network are allocated.

When it is necessary to transmit the same data to a plurality of terminals 100 belonging to the same group 10 that is distinguished by the MGID, the BS 200 includes data to transmit in a payload within a control message and transfers a corresponding control message to all terminals 100 within the group 10 through transmission of one time.

Further, the BS 200 includes and transmits scheduling information that a plurality of terminals 100 belonging to the same group 10 should receive in a control message. Scheduling information is radio resource information in which a data burst in which a plurality of terminals 100 belonging to the same group 10 are to receive is allocated. The terminal 100, having received a corresponding control message, may receive a data burst that is broadcasted using scheduling information that is included in a corresponding control message. The control message that is used at this time may be different according to a present state of the terminal 100. This will be described in detail.

First, a method of effectively transmitting common data to the terminal 100 in a connection state will be described.

In an IEEE 802.16m standard, in order to efficiently transmit data of less than 140 bytes such as a short sentence message service (SMS) to the terminal 100 in a connection state, an advanced air interface_L2_transfer message (AAI_L2-XFER) is used. The AAI_L2-XFER includes simple data such as an SMS, and may be transmitted to a control channel without connection setup to the terminal 100. However, in an IEEE 802.16m standard, the AAI_L2-XFER is transmitted with a unicast method to the terminal 100. Therefore, when transmitting common data to a plurality of terminals 100, the AAI_L2-XFER is not effective.

Therefore, in an exemplary embodiment of the present invention, by transmitting an advanced air interface_L2transfer_group message (AAI_L2-XFER-GRP) to the group 10 with a multicast method, common data are efficiently transmitted to a plurality of terminals 110. The AAI_L2-XFER-GRP to be transmitted in a unit of the group 10 includes information representing an actual transmission time point of individual data or common data, i.e., scheduling information of a data burst that can be transmitted to the terminal 100. A method of transmitting the AAI_L2-XFER-GRP in a group unit includes a method of transmitting through a broadcast MAP IE and a method of transmitting through a multicast MAP IE.

Hereinafter, a method of effectively transmitting common data to the terminal 100 in an idle state will be described.

In order to transmit data to the terminal 100 in an idle state, it should be firstly notified to the terminal 100 through paging regarding whether data that the terminal 100 should receive exists. In the communication system, in order to reduce power consumption, when data that the terminal 100 is to transmit/receive to and from the BS 200 do not exist, the terminal 100 periodically turns off the power supply of an apparatus for transmitting and receiving data to and from the BS 200 while entering an idle state, thereby reducing power consumption of the terminal 100. That is, the terminal 100 in an idle state checks whether there are data corresponding to the terminal 100 from the BS 200 by periodically inputting power to a transmitting/receiving apparatus, and if there are no data, the terminal 100 reduces power consumption by interrupting the power supply to the transmitting/receiving apparatus until a next awaking cycle. In such a situation, when the BS 200 has data to send to the terminal 100 in an idle state, the operation in which the BS 200 notifies the terminal 100 of the fact is referred to as paging.

The BS 200 transmits a paging signal, for example, a paging broadcasting message (AAI-PAG-ADV), to the terminal 100 in a listening interval in which the terminal 100 is awake, and receives a paging channel signal from the BS 200. The terminal 100, having received a paging signal for a listening interval determines whether the received signal is a signal for the terminal 100 according to whether the DID is included within the paging signal.

If the received signal is a signal for the terminal 100, the terminal 100 enters a network of the corresponding BS 200 and returns to a connection state in which it can smoothly transmit and receive data.

In this way, in order to transmit data to the terminal 100 in an idle state, the BS 200 should generally send a paging signal to the terminal 100 and first change a state of the terminal 100 to a connection state. An IEEE 802.16m standard provides a method in which the terminal 100 receives data while staying in an idle state instead of entering a connection state for a small size of data, for example, data having a size of less than 140 bytes. However, because such a method uses a unicast method, when transmitting common data to a plurality of idle terminals 110, the BS 200 transmits the same data to each of the plurality of terminals 110, thereby wasting a resource.

Therefore, according to an exemplary embodiment of the present invention, when transmitting common data to the plurality of idle terminals 110, the BS 200 can transmit data to the plurality of terminals 110 at one time with a multicast method.

A method of transmitting a paging signal with a multicast method includes an SMS extension method and a paging message extension method, and this will be described in detail.

First, the SMS extension method will be described in detail.

The SMS extension method is a method in which the terminal 110 in an idle state receives a control message, for example, a ranging response (AAI_RNG-RSP) control message including simple data such as SMS in an existing IEEE 802.16m or IEEE 802.16e standard, and of extracting data that are included in the control message and extending to multicast. That is, when the BS 200 transmits common data to terminals 110 in an idle state, the SMS extension method transmits a group SMS control message, for example, a ranging response group message (AAI_RNG-RSP-GRP) that is similar to an SMS control message and that is transferred to multicast. The group SMS control message includes position information of a burst including information representing a transmission time point of common data to transfer to all terminals 110 belonging to the group 10 or a burst including common data. Because the group SMS control message is transmitted in a group unit, even if the terminal 110 in an idle state does not enter a connection state, the BS 200 can efficiently transmit data at one time.

The group SMS control message may be transmitted through a broadcast MAP IE or through a multicast MAP IE. In this case, by including an MGID in a broadcast MAP IE or a multicast MAP IE instead of a conventional DID, it is represented that corresponding information is transmitted to all terminals 110 belonging to a specific group 10.

Hereinafter, a paging message extension method will be described in detail.

The paging message extension method is to transmit a paging message to a plurality of idle terminals 110 with a multicast method. That is, the paging message extension method uses a control message, for example, a paging broadcasting group message (AAI_PAG-ADV-GRP), that transmits a paging signal with a multicast method to the idle terminal 110 within the group 10. The AAI_PAG-ADV-GRP includes information representing a transmission time point of common data in which the entire group 10 should receive or a burst in which common data are included. Thereby, even if a terminal 110 in an idle state does not enter a connection state, the BS 200 can efficiently transmit common data at one time.

The AAI_PAG-ADV-GRP may be transmitted through a broadcast MAP IE or through a multicast MAP IE. In this case, by including the MGID instead of a DID of a conventional individual terminal 100 in the broadcast MAP IE or the multicast MAP IE, it is represented that corresponding information is transmitted to all terminals 110 belonging to a specific group 10.

When a paging signal and data to receive after paging are transmitted together to the terminal 110 using the AAI_PAG-ADV-GRP, a state of a plurality of terminals 110 belonging to the same group 10 in an idle state may be converted to a connection state at one time.

In order to send a paging signal in a unit of the group 10, it is unnecessary to use the AAI_PAG-ADV-GRP. In order to send a paging signal in a unit of the group 10, an existing paging signal transmission message used in existing IEEE 802.16m or IEEE 802.16e, for example, AAI_PAG-ADV and PAG-ADV, may be transmitted with a multicast data traffic transmission method using a broadcast MAP IE that is provided in IEEE 802.16m.

Hereinafter, a method of transmitting a message in a group unit through multicast will be described in detail.

As described above, a method of transmitting a message in a unit of the group 10 using multicast technology may include a method of using a broadcast MAP IE and a method of using a multicast MAP IE.

First, the method of using a broadcast MAP IE transmits a message for the group 10 through a broadcast MAP IE. In this case, when using AAI_L2-XFER, AAI_RNG-RSP, or AAI_PAG-ADV instead of a control message for group transmission, for example, AAI_L2-XFER-GRP, AAI_RNG-RSP-GRP, or AAI_PAG-ADV-GRP, as a code for cyclic redundancy check (CRC) masking in the broadcast MAP IE, a code for multicast assignment information that is designed for multicast data transmission in an IEEE 802.16m system may be used. It can be seen that contents within a burst in which the MAP IE indicates are multicast data using a value representing that a corresponding burst is multicast assignment information in the broadcast MAP IE. In this case, the MGID may include an M2M terminal group identifier that is newly defined in a field, for example, a multicast group identification (MGID) field representing a corresponding multicast identifier within the broadcast MAP IE. Therefore, the terminal 110 checks an MGID that is included within the broadcast MAP IE and determines whether a message is received. A newly defined MGID of the terminal 100 may include a terminal group in an idle state as well as a connection state, unlike a multicast identifier of a conventional system.

When using AAI_L2-XFER-GRP, AAI_RNGRSP-GRP, and AAI_PAG-ADV-GRP for group transmission, they may be transmitted in a broadcast burst form from the broadcast MAP IE. Therefore, a code for CRC masking is set to a code for a broadcast burst. When the AAI_L2-XFER-GRP, AAI_RNGRSP-GRP, and AAI_PAG-ADV-GRP are transmitted as a broadcast burst, other messages may be included and transmitted within the same broadcast burst. In this case, the MGID is included and transmitted within each control message. Therefore, after receiving all broadcast bursts that are transmitted through the broadcast MAP IE, the terminal 110 decodes a message that is included within a corresponding burst, checks an MGID that is included in the message, and finally determines whether the message is received.

Next, a method of using the multicast MAP IE is a method of newly making a multicast dedicated MAP IE and transmitting a group-based control message or data to terminals 110 that are combined into the group 10 using the multicast dedicated MAP IE. The multicast MAP IE may have a similar structure to a broadcast MAP IE, for example, a broadcast A-MAP IE of IEEE 802.16m, a broadcast MAP IE of IEEE 802.16e, or a unicast assignment MAP IE of IEEE 802.16e. In the multicast MAP IE, a corresponding MGID is transferred to the terminal 100 through CRC masking, as in the multicast MAP IE, or is added to a field of the broadcast MAP IE and is transferred to the terminal 110.

The multicast MAP IE may be embodied through extended assignment (EA) A-MAP IE of an IEEE 802.16m standard. In this case, the multicast MAP IE is classified by an EA A-MAP IE type field of an EA A-MAP IE.

The control message and data that are transferred through the multicast MAP IE may use the entire corresponding group 10 as a destination. Therefore, the control message and data in addition to a paging signal can also transfer at one time to the entire group 10 through the multicast MAP IE.

According to the present invention, in a basic M2M service system architecture, when transmitting common data to a plurality of new terminals in a conventional communication system, by including and transmitting common data in one burst on a group basis, common data are efficiently transmitted to a plurality of terminals, a data transmission load is reduced, and waste of a radio resource can be prevented.

Further, by transmitting one paging signal on a group basis to a plurality of terminals in an idle state, the plurality of terminals are guided to enter a connection state, and thus the plurality of terminals can be efficiently controlled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a base station transmits a signal to a plurality of terminals in a machine to machine (M2M) communication system, the method comprising:
grouping at least one of the plurality of terminals into a group terminal belonging to one group; and
allocating an M2M device group ID (MGID) that identifies the group terminal.

2. The method of claim 1, further comprising transmitting common data at one time to the group terminal.

3. The method of claim 2, wherein the transmitting of common data at one time to the group terminal comprises transmitting, when the group terminal is in an idle state, a paging broadcasting message to the group terminal.

4. The method of claim 3, wherein the paging broadcasting message is transmitted with a multicast method.

5. The method of claim 4, wherein the paging broadcasting message comprises information representing a transmission time point of a burst in which the common data are comprised.

6. The method of claim 5, wherein the paging broadcasting message is transmitted through a broadcast map information element (MAP IE).

7. The method of claim 6, wherein a code for multicast assignment information is used as a code for cyclic redundancy check masking in the broadcast MAP IE.

8. The method of claim 5, wherein the paging broadcasting message is transmitted through a multicast MAP IE.

9. The method of claim 3, wherein after the group terminal receives the common data, a state of the group terminal is converted to a connection state.

10. A method in which a base station transmits a signal to a plurality of terminals in an M2M communication system, the method comprising:
grouping at least one of a plurality of terminals into a group terminal belonging to one group; and
transmitting common data at one time to the group terminal.

11. The method of claim 10, wherein the transmitting of common data at one time to the group terminal comprises transmitting, when the group terminal is in an idle state, a paging broadcasting message to the group terminal.

12. The method of claim 11, wherein the paging broadcasting message is transmitted with a multicast method.

13. The method of claim 12, wherein the paging broadcasting message comprises information representing a transmission time point of burst in which the common data are comprised.

14. The method of claim 13, wherein the paging broadcasting message is transmitted through a broadcast MAP IE.

15. The method of claim 14, wherein a code for multicast assignment information is used as a code for cyclic redundancy check masking in the broadcast MAP IE.

16. The method of claim 13, wherein the paging broadcasting message is transmitted through a multicast MAP IE.

17. The method of claim 11, wherein after the group terminal receives the common data, a state of the group terminal is converted to a connection state.
